(19) United States
(12) Patent Application Publication
(10) Pub. No.: US 2019/0345963 A1
(43) Pub. Date: Nov. 14, 2019

(54) DEVICE-SECURING APPARATUS

(71) Applicant: THK CO., LTD., Tokyo (JP)

(72) Inventors: Hiroaki Mochizuki, Tokyo (JP); Eiji Hosaka, Tokyo (JP)

(73) Assignee: THK CO., LTD., Tokyo (JP)

(21) Appl. No.: 16/464,785

(22) PCT Filed: Dec. 13, 2017
(86) PCT No.: PCT/JP2017/044678

§ 371 Date: May 29, 2019

(30) Foreign Application Priority Data
Dec. 20, 2016 (JP) 2016-246114
Dec. 20, 2016 (JP) 2016-246190

(51) Int. Cl. F16B 5/10; F16B 1/02; B64D 11/06

(52) U.S. Cl. CPC F16B 5/10; B64D 11/06; F16B 1/02

(57) ABSTRACT

A device fixing apparatus, which is capable of suitably changing a fixing position of the device with respect to, for example, a floor surface of the structure, the device fixing apparatus including: a track rail, which is provided to the structure, has a plurality of rolling surfaces extending in a longitudinal direction of the track rail, and has a plurality of positioning holes at constant intervals along the longitudinal direction; a fixing terminal, which includes a plurality of guide wheels configured to roll on the track rail, and is configured to freely move by the guide wheels in the longitudinal direction of the track rail; and a restriction stud, which is mounted to the fixing terminal, and is suitably fitted to the positioning holes of the track rail to restrict movement of the fixing terminal with respect to the track rail.

### TECHNICAL FIELD

The present invention relates to a device fixing apparatus, which is configured to removably fix a device among various types at a suitable position on a rail through use of the rail installed on, for example, a floor surface, a wall surface, or a ceiling surface of a structure.

### BACKGROUND ART

When a device among various types is to be fixed to, for example, a floor surface, a wall surface, or a ceiling surface of a structure, it is convenient if a fixing position thereof can be suitably adjusted, and there has hitherto been known a device fixing apparatus using a rail having a special shape to be installed in the structure.

For example, in Patent Literature 1, there is disclosed a seat fixing apparatus configured to suitably change a seat arrangement in an aircraft. This apparatus includes a rail and a fixing terminal. The rail is installed on a floor surface in an aircraft, and has a recessed line groove extending along a longitudinal direction of the rail. The fixing terminal is inserted into the recessed line groove of the rail, and can be fixed at a suitable position on the rail.

### CITATION LIST

### Patent Literature

[PTL 1] JP 4705106 B2

### DISCLOSURE OF THE INVENTION

### Problems to be Solved by the Invention

The related-art device fixing apparatus gives focus on the feature that the fixing terminal can be removably mounted at a suitable position on the rail, and no consideration has been made on whether or not the fixing terminal can be easily moved in the recessed line groove of the rail in order to change the fixing position of the device with respect to the floor surface.

Therefore, even in a case in which it is desired that, for example, the seat arrangement in the aircraft be changed in a short period of time, there is difficulty in promptly moving the seat with less labor. Moreover, there is also a problem in terms of electrification of the operation of changing the seat arrangement in the aircraft.

### Means for Solving the Problems

The present invention has been made in view of such cases, and has an object to provide a device fixing apparatus capable of easily changing a fixing position of a device with respect to, for example, a floor surface of a structure.

That is, according to one embodiment of the present invention, there is provided a device fixing apparatus, which is configured to fix a device to a structure, and is capable of suitably changing a fixing position of the device with respect to the structure, the device fixing apparatus including: a track rail, which is provided to the structure, has a plurality of rolling surfaces extending in a longitudinal direction of the track rail, and has a plurality of positioning holes at constant intervals along the longitudinal direction; a fixing terminal, which includes a plurality of guide wheels configured to roll on the track rail, and is configured to freely move by the guide wheels in the longitudinal direction of the track rail; and a restriction stud, which is mounted to the fixing terminal, and is suitably fitted to the positioning holes of the track rail to restrict movement of the fixing terminal with respect to the track rail.

### Effects of the Invention

According to the present invention, a plurality of guide wheels configured to roll on the plurality of rolling surfaces of the track rail are provided to the fixing terminal, and the fixing terminal is freely movable in the longitudinal direction of the track rail by the guide wheels. Therefore, when the fitting between the restriction stud and the positioning hole of the track rail is cancelled, the fixing terminal fixing the device can be moved with respect to the track rail, thereby being capable of changing the fixing position of the device with respect to, for example, a floor surface.

### BRIEF DESCRIPTION OF DRAWINGS

FIG. 1 is a front view for illustrating a device fixing apparatus according to a first embodiment of the present invention.

FIG. 2 is a side view for illustrating the device fixing apparatus according to the first embodiment.

FIG. 3 is a view for illustrating arrangement of guide wheels of a fixing terminal in the first embodiment.

FIG. 4 is a front view for illustrating a device fixing apparatus according to a second embodiment of the present invention.

FIG. 5 is a view for illustrating arrangement of guide wheels of a fixing terminal in the second embodiment.

FIG. 6 is a side view for illustrating the device fixing apparatus according to the second embodiment.

FIG. 7 is a perspective view for illustrating a device fixing apparatus according to a third embodiment of the present invention.

FIG. 8 is a perspective view for illustrating a device fixing apparatus according to a fourth embodiment of the present invention.

FIG. 9 is a sectional view for illustrating a track rail in the fourth embodiment.

FIG. 10 is a plan view for illustrating arrangement of guide wheels on a fixing terminal in the fourth embodiment.

### MODE FOR CARRYING OUT THE INVENTION

Now, with reference to the accompanying drawings, detailed description is made of a device fixing apparatus according to the present invention.

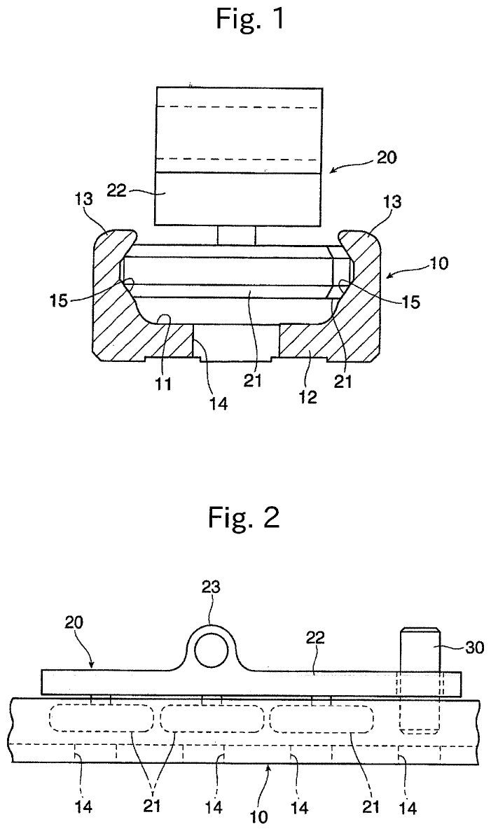

FIG. 1 and FIG. 2 are views for illustrating a device fixing apparatus according to a first embodiment of the present invention. The device fixing apparatus includes a track rail 10, a fixing terminal 20, and a restriction stud 30. The track rail 10 is fixed to a floor surface, a wall surface, or a ceiling surface of a structure. The fixing terminal 20 is freely movable along a longitudinal direction of the track rail 10. The restriction stud 30 is configured to restrict the fixing terminal 20 at a suitable position on the track rail 10.

The track rail 10 has a groove portion 11 extending along the longitudinal direction so as to have a substantially C-shape in cross section, and includes a bottom portion 12 and a pair of side walls 13 surrounding the groove portion 11. The bottom portion 12 has positioning holes 14 configured to receive the restriction stud 30 fitted thereto, and the positioning holes 14 are formed at constant intervals along the longitudinal direction of the track rail 10. On inner side surfaces of the side walls 13 facing the groove portion 11, rolling surfaces 15 are formed so as to extend along the longitudinal direction of the track rail 10, and guide wheels 21 provided to the fixing terminal 20 roll on the rolling surfaces 15.

The fixing terminal 20 is freely movable in the groove portion 11 of the track rail 10. The fixing terminal 20 includes a terminal main body 22 and a plurality of, for example, three or more guide wheels 21 mounted to the terminal main body 22. The guide wheels 21 are provided so as to be freely rotatable about respective support shafts fixed to the terminal main body 22, and roll on the rolling surfaces 15 formed on the side walls 13 of the track rail 10 while rotating. Moreover, a sectional shape of an outer peripheral portion of each of the guide wheels 21 is approximated to a sectional shape of each of the rolling surfaces 15 formed on the side walls 13 of the track rail 10. Under a state in which the guide wheels 21 are pressed against the rolling surfaces 15, the guide wheels 21 are not removable from the rolling surfaces 15.

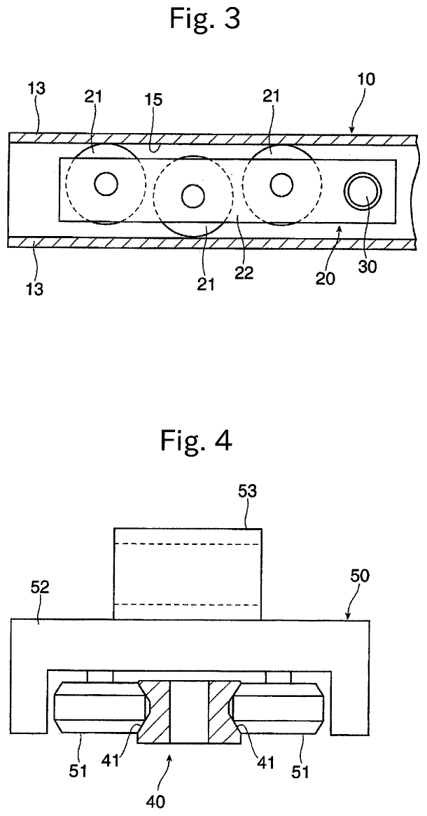

As illustrated in FIG. 3, the plurality of guide wheels 21 arranged on the terminal main body 22 are arranged in a staggered pattern along the longitudinal direction of the track rail 10 and are inserted into the groove portion 11 of the track rail 10, and are in contact with the rolling surface 15 of any one of the side walls 13 in the groove portion 11. For example, when three guide wheels 21 are provided to the terminal main body 22, one guide wheel 21 is in contact with one side wall 13, and two guide wheels 21 are in contact with another side wall 13. Therefore, when the guide wheels 21 are pressed against the rolling surfaces 15 of the side walls 13 with an adequate force, the fixing terminal 20 is restricted in a direction orthogonal to the longitudinal direction of the track rail 10, and hence the fixing terminal 20 can freely reciprocate in the longitudinal direction of the track rail 10 while bearing a load.

The restriction stud 30 is mounted to the terminal main body 22 of the fixing terminal 20, and can be set to any one of an engagement position and a release position with respect to the terminal main body 22. When the restriction stud 30 is set to the engagement position, a distal end of the restriction stud 30 is fitted to the positioning hole 14 formed in the track rail 10. Therefore, when the restriction stud 30 is set to the engagement position, the fixing terminal 20 is immovable in the longitudinal direction of the track rail 10, and hence the fixing terminal 20 is fixed to the track rail 10. Moreover, when the restriction stud 30 is set to the release position, the distal end of the restriction stud 30 moves out from the positioning hole 14 of the track rail 10, and hence the fixing terminal 20 is movable in the longitudinal direction of the track rail 10. Thus, when the positioning holes 14 are arrayed at constant intervals along the longitudinal direction of the track rail 10, a fixing position of the fixing terminal 20 with respect to the track rail 10 can be suitably changed at the array intervals of the positioning holes 14. FIG. 2 is an illustration of a state in which the restriction stud 30 is set to the release position, and the fixing terminal 20 is movable with respect to the track rail 10.

The fixing terminal 20 includes a connection portion 23 configured to connect a device among various types. The connection portion 23 in this embodiment has a through hole for insertion of a coupling pin. However, for example, a device among various types maybe fastened to the connection portion 23 directly with a bolt.

When the device fixing apparatus according to this embodiment is to be used, the track rail 10 maybe directly installed on the structure. However, for example, when an existing rail is already present as in a case of a floor surface in an aircraft, the track rail 10 may be fixed to the existing rail.

In the device fixing apparatus according to this embodiment having the configuration described above, the rolling surfaces 15 are formed on the inner side surfaces of the pair of side walls 13 surrounding the groove portion 11 of the track rail 10, and the plurality of guide wheels 21 configured to roll on the rolling surfaces 15 are provided to the fixing terminal 20. Therefore, the fixing terminal 20 can easily move in the longitudinal direction of the track rail 10, thereby being capable of easily changing a fixing position of the device with respect to, for example, a floor surface of a structure.

Moreover, when the restriction stud 30 mounted to the fixing terminal 20 is set to the engagement position, the fixing terminal 20 is immovable in the longitudinal direction of the track rail 10, and hence the fixing terminal 20 can be fixed at a suitable position on the track rail 10.

Thus, when the device fixing apparatus according to the present invention is used as a seat fixing apparatus in an aircraft, a seat can be easily and promptly moved with less labor, thereby being capable of changing the seat arrangement in the aircraft in a short period of time.

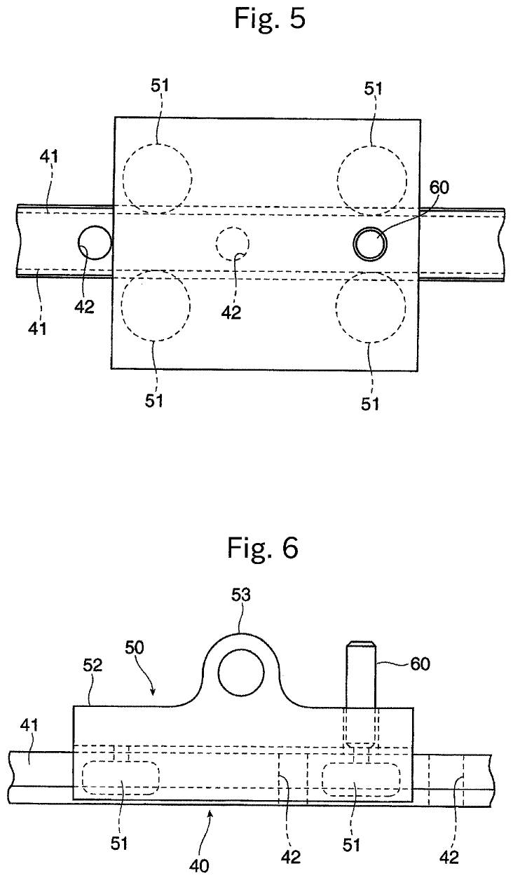

FIG. 4 to FIG. 6 are views for illustrating a device fixing apparatus according to a second embodiment of the present invention.

The device fixing apparatus of the second embodiment includes a track rail 40, a fixing terminal 50, and a restriction stud 60. The track rail 40 is fixed to a floor surface, a wall surface, or a ceiling surface of a structure. The fixing terminal 50 is freely movable along a longitudinal direction of the track rail 40. The restriction stud 60 is configured to restrict the fixing terminal 50 at a suitable position on the track rail 40.

The track rail 40 has a substantially rectangular sectional shape in a direction perpendicular to the longitudinal direction, and rolling surfaces 41 are formed along the longitudinal direction of the track rail 40 on a pair of side surfaces facing in opposite directions. Guide wheels 51 provided to the fixing terminal 50 roll on the rolling surfaces 41. Moreover, the track rail 40 has positioning holes 42 configured to receive the restriction stud 60 to be fitted thereto, and the positioning holes 42 are formed at constant intervals along the longitudinal direction of the track rail 40.

The fixing terminal 50 is freely movable along the track rail 40. The fixing terminal 50 includes a terminal main body 52 and a plurality of guide wheels 51 mounted to the terminal main body 52. The guide wheels 51 are provided so as to be freely rotatable about respective support shafts fixed to the terminal main body 52, and roll on the rolling surfaces 41 formed on the side surfaces of the track rail 40 while rotating. Moreover, a sectional shape of an outer peripheral portion of each of the guide wheels 51 is approximated to a sectional shape of each of the rolling surfaces 41 formed on the side surfaces of the track rail 40. Under a state in which the guide wheels 51 are pressed against the rolling surfaces 41, the guide wheels 51 are not removable from the rolling surfaces 41.

The fixing terminal 50 includes a plurality of guide wheels 51 corresponding to both side surfaces of the track rail 40. For example, when an odd number of, such as three or five, guide wheels 51 are provided to the fixing terminal 50, it is conceivable to arrange those guide wheels 51 in a staggered pattern with respect to the terminal main body 52 and sandwich the track rail 40 from both sides. Moreover, when an even number of, such as four or six, guide wheels 51 are provided to the fixing terminal 50, it is conceivable to regard two guide wheels 51 as one set and sandwich the track rail 40 with each group of guide wheels 51. When the guide wheels 51 are pressed against the rolling surfaces 41 of the track rail 40 with an adequate force, the fixing terminal 50 is restricted in a direction orthogonal to the longitudinal direction of the track rail 40, and hence the fixing terminal 50 can freely reciprocate in the longitudinal direction of the track rail 40 while bearing a load.

The restriction stud 60 is mounted to the terminal main body 52 of the fixing terminal 50, and can be set to any one of an engagement position and a release position with respect to the terminal main body 52. When the restriction stud 60 is set to the engagement position, a distal end of the restriction stud 60 is fitted to the positioning hole 42 formed in the track rail 40. Thus, when the restriction stud 60 is set to the engagement position, the fixing terminal 50 is immovable in the longitudinal direction of the track rail 40. Moreover, when the restriction stud 60 is set to the release position, the fixing terminal 50 is movable in the longitudinal direction of the track rail 40. FIG. 6 is an illustration of a state in which the restriction stud 60 is set to the release position.

Similarly to the first embodiment, a connection portion 53 configured to connect a device among various types is provided to the fixing terminal 50, and the connection portion 53 may have any shape as long as a device among various types can be fixed. The track rail 40 may be directly installed on the structure. However, for example, when an existing rail is already present as in a case of a floor surface in an aircraft, the track rail 40 may be fixed to the existing rail.

Also in the device fixing apparatus according to the second embodiment having the configuration described above, the fixing terminal 50 can easily move in the longitudinal direction of the track rail 40, thereby being capable of easily changing a fixing position of a device with respect to a floor surface of a structure. Moreover, when the restriction stud 60 is set to the engagement position, the fixing terminal 50 can be fixed at a suitable position on the track rail 40.

Thus, when the device fixing apparatus according to the second embodiment is used as a seat fixing apparatus in an aircraft, a seat can be easily and promptly moved with less labor, thereby being capable of changing the seat arrangement in the aircraft in a short period of time.

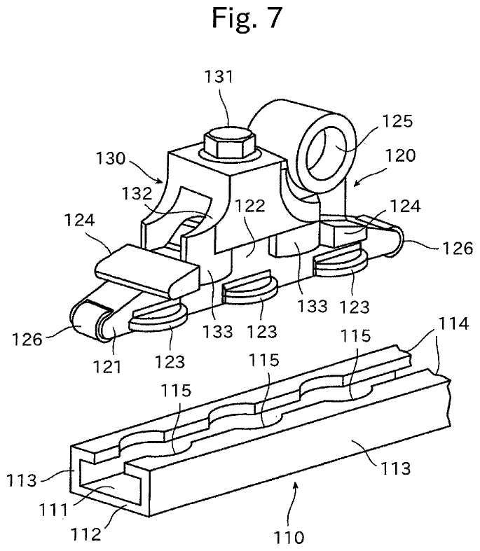

FIG. 7 is a view for illustrating a device fixing apparatus according to a second embodiment of the present invention.

The device fixing apparatus according to the third embodiment can be used for the purpose of fixing a seat on a floor surface in an aircraft. The device fixing apparatus according to the third embodiment includes, for example, a track rail 110, a fixing terminal 120, and a clamp member 130. The track rail 110 is fixed to a floor surface in an aircraft. The fixing terminal 120 is fixed at a suitable position on the track rail 110, and receives a leg portion of the seat connected thereto. The clamp member 130 is configured to restrict movement of the fixing terminal 120 in a longitudinal direction of the track rail 110. FIG. 7 is an illustration of a state in which the track rail 110 and the fixing terminal 120 are separated from each other.

The track rail 110 has a groove portion 111 extending along the longitudinal direction and has a channel shape. The groove portion 111 is surrounded by a bottom portion 112 and a pair of side walls 113. Holding portions 114 are provided at upper ends of the pair of side walls 113, respectively. The holding portions 114 extend along the longitudinal direction of the track rail 110 and protrude above the groove portion 111. An opening portion having a slit shape is defined between the pair of holding portions 114 protruding above the groove portion 111, and the opening portion serves as a movement passage for the fixing terminal 120.

Moreover, a plurality of positioning holes 115 are formed in the track rail 110. The plurality of positioning holes 115 are formed by cutting out the holding portions 114. Those positioning holes 115 are formed at constant intervals along the longitudinal direction of the track rail 110. The holding portions 114 are divided by the positioning holes 115, and the opening portions are increased in width at forming positions of the positioning holes 115.

Meanwhile, the fixing terminal 120 includes a slide portion 121 and a main body portion 122. The slide portion 121 is inserted into the groove portion 111 of the track rail 110. The main body portion 122 projects on the track rail 110 and includes a connection portion for a device such as a seat. The slide portion 121 and the main body portion 122 are formed integrally with each other. The slide portion 121 and the main body portion 122 are formed with a width slightly smaller than an opening width of the opening portion of the track rail 110. The main body portion 122 has a bolt mounting hole 125 for fixing a device such as a seat.

A plurality of stopper portions 123 project from both side surfaces of the slide portion 121. The stopper portions 123 are each formed so as to have a size which allows the stopper portions 123 to pass through the positioning holes 115 of the track rail 110. In the example illustrated in FIG. 7, three stopper portions 123 are provided on one side surface of the slide portion 121, and the stopper portions 123 are arrayed at intervals equal to array intervals of the positioning holes 115 with respect to the track rail 110. Therefore, with the stopper portions 123 fitted to the positioning holes 115, the slide portion 121 of the fixing terminal 120 can be inserted into and taken out from the groove portion 111 of the track rail 110 from above the track rail 110. Moreover, after the slide portion 121 is inserted into the groove portion 111 of the track rail 110, when the slide portion 121 is moved in the longitudinal direction of the track rail 110 by half the array intervals of the positioning holes 115, the stopper portions 123 interfere with the holding portions 114 of the track rail 110. Thus, the slide portion 121 is brought into a state of being irremovable from the groove portion 111 of the track rail 110.

Moreover, a plurality of locking protrusions 124 are formed on both side surfaces of the main body portion 122 of the fixing terminal 120. The locking protrusions 124 are provided at positions overlapping the stopper portions 123 provided to the slide portion 121. Under a state in which the slide portion 121 is inserted into the groove portion 111 of the track rail 110, the holding portions 114 of the track rail 110 are located between the stopper portions 123 and the locking protrusions 124 so that, without interference between the locking protrusions 124 and the holding portions 114, the fixing terminal 120 is movable along the longitudinal direction of the track rail 110. Thus, after the slide portion 121 is inserted into the groove portion 111 of the track rail 110, when the slide portion 121 is moved in the longitudinal direction of the track rail 110 by half the array intervals of the positioning holes 115, the holding portions 114 of the track rail 110 are brought into a state of being inserted into a gap defined between the stopper portions 123 and the locking protrusions 124 of the fixing terminal 120.

Further, on front and rear sides of the slide portion 121 along the longitudinal direction of the track rail 110, a pair of guide wheels 126, which are freely rotatable, are axially supported. The guide wheels 126 are each formed such that an axial length thereof is shorter than a width of the slide portion 121. When the slide portion 121 is inserted into the groove portion 111 of the track rail 110, the guide wheels 126 fit in the groove portion 111 together with the slide portion 121. Those guide wheels 126 roll on a surface of the bottom portion 112 of the track rail 110 to guide movement of the slide portion 121 in the groove portion 111. A diameter of each of the guide wheels 126 is set smaller than a height of the groove portion 111, that is, a distance from the bottom portion 112 to the holding portions 114. Thus, the guide wheels 126 axially supported by the slide portion 121 are capable of freely rolling in the groove portion 111.

The clamp member 130 configured to restrict movement of the fixing terminal 120 with respect to the longitudinal direction of the track rail 110 is mounted to the fixing terminal 120. The clamp member 130 is provided so as to extend across the main body portion 122 of the fixing terminal 120. Through turning of a fixing screw 131 threadedly engaged with the main body portion 122, the clamp member 130 moves in the up-and-down direction with respect to the main body portion 122. The clamp member 130 includes a pair of skirt portions 132 configured to move in the up-and-down direction along side surfaces of the main body portion 122, and a plurality of restriction studs 133 corresponding to the positioning holes 115 of the track rail 10 are provided at lower ends of the skirt portions 132. In the longitudinal direction of the track rail 110, each restriction stud 133 is located at an intermediate position between the stopper portion 123 arrayed on the main body portion 122 of the fixing terminal 120. When the fixing screw 131 is tightened to lower the clamp member 130 toward the track rail 110, the restriction studs 133 are fitted to the positioning holes 115 of the track rail 110 so that movement of the fixing terminal 120 along the longitudinal direction of the track rail 110 is restricted. Moreover, when the fixing screw 131 is tightened to lower the clamp member 130 toward the track rail 110, under a state in which the restriction stud 133 is fitted to the positioning holes 115 of the track rail 110, lower end surfaces of the skirt portions 132 of the clamp member 130 press the holding portions 114 of the track rail 110 from above.

In order to fix the fixing terminal 120 to the track rail 110, first, under a state in which the fixing screw 131 of the clamp member 130 is loosened, the stopper portions 123 formed on the slide portion 121 of the fixing terminal 120 are fitted to the positioning holes 115 of the track rail 110, and the slide portion 121 is inserted into the groove portion 111 of the track rail 110. When the slide portion 121 is inserted into the groove portion 111, the guide wheels 126 provided to the fixing terminal 120 are brought into abutment against the bottom portion 112 of the track rail 110, and the guide wheels 126 roll with respect to the track rail 110. Accordingly, the slide portion 121 of the fixing terminal 120 can be freely moved in the groove portion 111 of the track rail 110.

After the fixing terminal 120 is moved to a suitable position on the track rail 110, the fixing screw 131 is tightened so that the restriction studs 133 of the clamp member 130 are fitted to the positioning holes 115 of the track rail 110. With this, the fixing terminal 120 becomes immovable with respect to the longitudinal direction of the track rail 110, and the holding portions 114 of the track rail 110 are brought into a state of being sandwiched between the stopper portions 123 of the fixing terminal 120 and the skirt portions 122 of the clamp member 130. Thus, the fixing terminal 120 is fixed with respect to the track rail 110.

According to the device fixing apparatus of the third embodiment, through loosening of the fixing screw 131, the fixing terminal 120 can be easily moved along the track rail 110 while the slide portion 121 of the fixing terminal 120 is being inserted into the groove portion 111 of the track rail 110. Moreover, after the fixing terminal 120 is moved along the track rail 110, through tightening of the fixing screw 131, the fixing terminal 120 can be reliably fixed at a suitable position on the track rail 110.

Thus, when the device fixing apparatus is used for fixing a seat in an aircraft, arrangement of a seat in the aircraft can be easily and promptly changed with less labor.

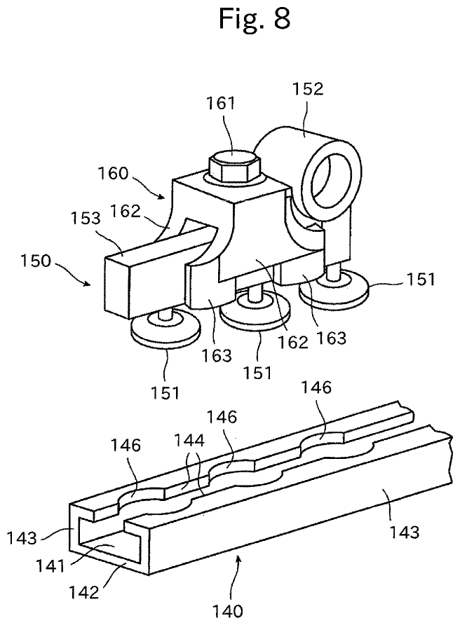

FIG. 8 is a view for illustrating a forth embodiment of the device fixing apparatus.

Similarly to the third embodiment, the device fixing apparatus according to the fourth embodiment is usable for fixing a seat in an aircraft. The device fixing apparatus includes a track rail 140, a fixing terminal 150, and a clamp member 160. The track rail 140 is fixed to a floor surface in an aircraft. The fixing terminal 150 is fixed at a suitable position on the track rail 140, and receives a leg portion of the seat connected thereto. The clamp member 160 is configured to restrict movement of the fixing terminal 150 in a longitudinal direction of the track rail 140.

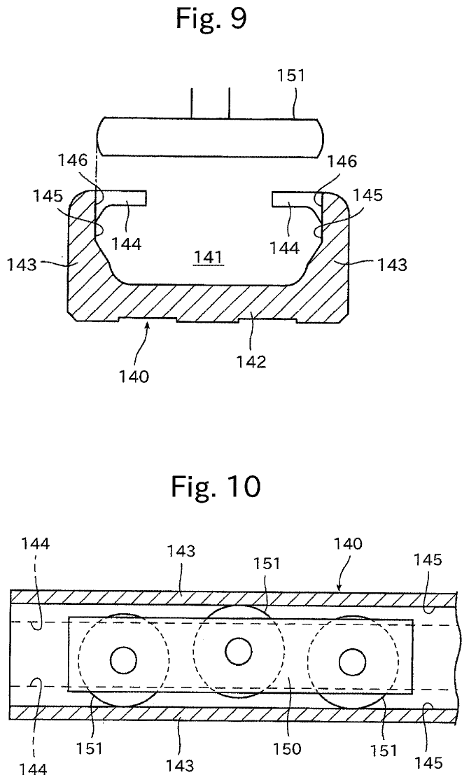

The track rail 140 has a groove portion 141 extending in the longitudinal direction and has a channel shape. The groove portion 141 is surrounded by a bottom portion 142 and a pair of side walls 143. Holding portions 144 are provided at upper ends of the pair of side walls 143, respectively. The holding portions 144 extend along the longitudinal direction of the track rail 140 and protrude above the groove portion 141. FIG. 9 is an illustration of a cross section orthogonal to the longitudinal direction of the track rail 140. On inner side surfaces of the pair of side walls 143 facing the groove portion 141, there are formed rolling surfaces 145 for guide wheels 151 described later, and the rolling surfaces 145 are each formed into a recessed curved shape conforming to the shape of the guide wheels 151. An opening portion having a slit shape is defined between the pair of holding portions 144 protruding above the groove portion 141, and the opening portion serves as a movement passage for the fixing terminal 150.

Moreover, a plurality of positioning holes 146 are formed in the track rail 140. The plurality of positioning holes 146 are formed by cutting out the holding portions 144. Those positioning holes 146 are formed at constant intervals along the longitudinal direction of the track rail 140. The holding portions 144 are divided by the positioning holes 146, and the opening portions are increased in width at forming positions of the positioning holes 146. The positioning holes 146 are formed by completely removing the holding portions 144. As illustrated in FIG. 9, at each of forming positions of the positioning holes 146, a deepest portion of the rolling surface 145 and an inner peripheral surface of the positioning hole 146 match each other.

Meanwhile, the fixing terminal 150 includes a plurality of, specifically, three or more guide wheels 151 and a main body portion 153. The guide wheels 151 are inserted into the groove portion 141 of the track rail 140 and roll on the rolling surfaces 145 formed on the side walls 143 of the track rail 140. The main body portion 153 is supported on the track rail 140 by the guide wheels 151 and includes a connection portion 152 for a device such as a seat. Through rolling of each of the guide wheels 151 on the rolling surfaces 145 formed on the inner side surfaces of the side walls 143 of the track rail 140, the main body portion 153 is freely movable on the track rail 140 along the longitudinal direction of the track rail 140.

The guide wheels 151 are supported through intermediation of respective support shafts on a lower surface side of the main body portion 153, and are inserted into the groove portion 141 of the track rail 140. Each of outer peripheral surfaces of the guide wheels 151 is formed into a protruding curved shape, and the shape matches with the rolling surfaces 145 having the recessed curved shape formed on the side walls 143 of the track rail 140. That is, the guide wheels 151 roll on the rolling surfaces 145 while being in surface contact with the rolling surfaces 145.

As illustrated in FIG. 10, in the fourth embodiment, three guide wheels 151 are provided to the main body portion 153, and two guide wheels 151 among those guide wheels roll on one side wall 143 of the track rail 140, and another one guide wheel 151 roll on another side wall 143 of the track rail 140. That is, the three guide wheels 151 are arranged in a staggered pattern with respect to the longitudinal direction of the track rail 140, and are each pressed against the rolling surfaces 145 of the track rail 140. With this, the fixing terminal 150 is restricted in a direction orthogonal to the longitudinal direction of the track rail 140, and hence the fixing terminal 150 can freely reciprocate in the longitudinal direction of the track rail 140 while bearing a load.

The guide wheels 151 allow the fixing terminal 150 to freely move with respect to the track rail 140, and function also as stopper portions of the present invention. The three guide wheels 151 are arrayed at the same intervals as the array intervals of the positioning holes 146 with respect to the track rail 140. Moreover, as described above with reference to FIG. 10, the inner peripheral surface of the positioning hole 146 matches with the deepest portion of the rolling surface 145. Therefore, through fitting of the guide wheels 151 to the positioning holes 146, the guide wheels 151 can be inserted into the groove portion 141 of the track rail 140 through the positioning holes 146, thereby being capable of allowing the guide wheels 151 to be brought into abutment against the rolling surfaces 145. Moreover, after the guide portion 151 is inserted into the groove portion 141 of the track rail 140, when the fixing portion 150 is moved in the longitudinal direction of the track rail 140 by half the array intervals of the positioning holes 146, the guide portions 151 interfere with the holding portions 144 of the track rail 140. Thus, the guide portion 151 is brought into a state of being irremovable from the groove portion 141 of the track rail 140.

The clamp member 160 configured to restrict movement of the fixing terminal 150 with respect to the longitudinal direction of the track rail 140 is mounted to the fixing terminal 150. The clamp member 160 is provided so as to extend across the main body portion 153 of the fixing terminal 150. Through turning of a fixing screw 161 threadedly engaged with the main body portion 153, the clamp member 160 moves in the up-and-down direction with respect to the main body portion 153. The clamp member 160 includes a pair of skirt portions 162 configured to move in the up-and-down direction along side surfaces of the main body portion 153, and a plurality of restriction studs 163 corresponding to the positioning holes 115 are provided at lower ends of the skirt portions 162. In the longitudinal direction of the track rail 140, each restriction stud 163 is located at an intermediate position between the guide wheels 151 provided to the main body portion 153 of the fixing terminal 150. When the fixing screw 161 is tightened to lower the clamp member 160 toward the track rail 140, the restriction studs 163 are fitted to the positioning holes 146 of the track rail 140 so that movement of the fixing terminal 150 along the longitudinal direction of the track rail 140 is restricted. Moreover, when the fixing screw 161 is tightened to lower the clamp member 160 toward the track rail 140, under a state in which the restriction stud 163 is fitted to the positioning holes 146 of the track rail 140, lower end surfaces of the skirt portions 162 of the clamp member 160 press the holding portions 144 of the track rail 140 from above.

In order to fix the fixing terminal 150 to the track rail 140, first, under a state in which the fixing screw 161 of the clamp member 160 is loosened, the guide wheels 151 formed on the fixing terminal 150 are fitted to the positioning holes 146 of the track rail 140, and the guide wheels 151 is inserted into the groove portion 141 of the track rail 140. The guide wheels 151 inserted into the groove portion 141 are brought into the rolling surfaces 145 formed on the side walls 143 of the track rail 140, and the guide wheels 151 roll with respect to the track rail 140. With this, the fixing terminal 150 can be freely moved in the longitudinal direction of the track rail 140.

After the fixing terminal 150 is moved to a suitable position on the track rail 140, the fixing screw 161 is tightened so that the restriction studs 163 of the clamp member 160 are fitted to the positioning holes 146 of the track rail 140. With this, the fixing terminal 150 becomes immovable with respect to the longitudinal direction of the track rail 140, and the holding portions 144 of the track rail 140 are brought into a state of being sandwiched between the guide wheels 151 of the fixing terminal 120 and the skirt portions 162 of the clamp member 160. Thus, the fixing terminal 150 is fixed with respect to the track rail 140.

Therefore, according to the device fixing apparatus of the forth embodiment, through loosening of the fixing screw 161, the fixing terminal 150 can be easily moved along the track rail 140 while the guide wheels 151 of the fixing terminal 150 is being inserted into the groove portion 141 of the track rail 140. Moreover, after the fixing terminal 150 is moved along the track rail 140, through tightening of the fixing screw 161, the fixing terminal 150 can be reliably fixed at a suitable position on the track rail 140.

Thus, when the device fixing apparatus of this forth embodiment is used for fixing a seat in an aircraft, arrangement of a seat in the aircraft can be easily and promptly changed with less labor.

1. A device fixing apparatus, which is configured to fix a device to a structure, and is capable of suitably changing a fixing position of the device with respect to the structure, the device fixing apparatus comprising:
a track rail, which is provided to the structure, has a plurality of rolling surfaces extending in a longitudinal direction of the track rail, and has a plurality of positioning holes at constant intervals along the longitudinal direction;
a fixing terminal, which includes a plurality of guide wheels configured to roll on the track rail, and is configured to freely move by the guide wheels in the longitudinal direction of the track rail; and
a restriction stud, which is mounted to the fixing terminal, and is suitably fitted to the positioning holes of the track rail to restrict movement of the fixing terminal with respect to the track rail.

2. The device fixing apparatus according to claim 1,
wherein the track rail includes:
a groove portion, which is surrounded by a bottom portion and a pair of side walls, and extends along the longitudinal direction; and
holding portions protruding above the groove portion from the pair of side walls, and
wherein the side walls have the rolling surfaces on respective inner side surfaces thereof, and the bottom portion have positioning holes.

3. The device fixing apparatus according to claim 1, wherein the track rail has a rectangular cross section orthogonal to the longitudinal direction, and has the rolling surfaces on both side surfaces thereof.

4. The device fixing apparatus according to claim 1,
wherein the track rail includes:
a groove portion, which is surrounded by a bottom portion and a pair of side walls, and extends along the longitudinal direction; and
holding portions protruding above the groove portion from the pair of side walls,
wherein the track rail has a plurality of positioning holes, which are formed by cutting out the holding portions at predetermined intervals in the longitudinal direction, and
wherein the fixing terminal includes stopper portions inserted into the groove portion through the positioning holes, and is held in the groove portion of the track rail through engagement between the stopper portions and the holding portions.

5. The device fixing apparatus according to claim 4, wherein the plurality of guide wheels are provided at a front end and a rear end of the fixing terminal in a moving direction of the fixing terminal, and are configured to roll on the rolling surfaces formed on the bottom portion of the track rail.

6. The device fixing apparatus according to claim 4, wherein the rolling surfaces are formed on a pair of side walls of the track rail, and the plurality of guide wheels configured to roll on the rolling surfaces function as the stopper portions.
